(19) United States
(12) Patent Application Publication
(10) Pub. No.: US 2004/0192124 A1
(43) Pub. Date: Sep. 30, 2004

(54) Electric personal water crafts

(76) Inventor: Mark Howard Krietzman, Palos Verdes Estates, CA (US)

Correspondence Address: Mark Krietzman, P.O. Box 3185, Palos Verdes, CA, 90274, US

(21) Appl. No.: 10/802,551

(22) Filed: Mar. 17, 2004

Related U.S. Application Data
(63) Continuation-in-part of application No. 10/374,477, filed on Feb. 25, 2003.
(60) Provisional application No. 60/497,282, filed on Aug. 22, 2003.

(51) Int. Cl. B60L 11/02

(52) U.S. Cl. 440/6

(57) ABSTRACT

An electric personal water craft. The electric personal water craft produces its own electricity from an on-board fuel cell system. Hydrogen fuel is stored or produced within the hull of the personal water craft. The heat produced by the fuel cell stack can dissipated to the marine environment for heat management of the fuel cell power system. Output from the fuel cell system may also be stored in a rechargeable NiMH battery and used alone or in conjunction with the fuel cell to provide electricity for the electric propulsion.

### RELATED APPLICATION

This patent application is a continuation-in-part of Applicant's Pending Patent Application entitled “Electric Personal Water Craft” Ser. No.: 10/374,477 filed Feb. 25, 2003 which is incorporated herein by this reference. This patent application also claims the benefit of Applicant's provisional patent application entitled “Electric Personal Water Crafts” filed Aug. 22, 2003 60/497282 which is hereby incorporated by this reference.

### BACKGROUND OF THE INVENTION

1. Field of the Invention

This present invention relates to an electric personal watercraft with electricity supplied by a fuel cell stack. More specifically, to an electric propulsion system and method for a small sized electric marine craft.

2. Background Art

The personal water craft “PWC” is commonly known as a small marine vessel with limited seating. Prior art PWC's use an inboard internal combustion engine (ICE) to power a water jet pump. The PWC has limited hull space for electronics, fuel and propulsion systems.

The PWC can also be dirty and noisy. The PWC is the subject of restrictions in areas such as national parks (see 36 Code of Federal Regulations 13.63 (h) (i)). The majority of PWC's are powered by a two-stroke ICE which uses a mixture of gasoline and oil for fuel. Unfortunately, about one third of the oil and gasoline mixture is unburned and introduced into the surrounding environment. The California Air Resources Board (CARB) has reported that a days ride on a 100 horsepower PWC emits the same amount of smog as driving 100,000 miles in a modern automobile, see “Proposed Regulations for Gasoline Spark-Ignition Marine Engines, Draft Proposal Summary” Mobile Source Control Division , State of California Air Resources Board; Jun. 11, 1998.

PWCs are highly maneuverable making them suitable for a variety of recreational, law enforcement and military activities. However, the noise and pollution problems of the ICE can limit their use. Some PWC are constructed with two seats side-by-side with occupants surrounded by at least a partial hull, others place one or more riders on a raised hull section.

Electric motors have been used in marine crafts for slow speed navigation and trolling. Electric motors have also been used as secondary low speed propulsion or for low speed navigation in marine crafts which have a primary propulsion provided by an ICE, see generally U.S. Pat. Nos. 6,305,994 and 6,361,385 issued to Bland et. al.

Conventional batteries (lead acid) have been used to supply electricity for low speed propulsion of marine water crafts. Conventional batteries are, however, bulky, heavy, and slow to recharge. A PWC has limited weight carrying capacity and limited hull space which cannot easily accommodate the quantity of conventional batteries which would be required of prolonged high speed electrical propulsion. The PWC is often used in recreational settings which may be remote. This type of usage makes long recharge times, or recharge from the electric grid impractical and/ or inconvenient. Accordingly, conventional batteries are a poor choice to power an electric PWC if one is striving for performance characteristics not unlike an ICE PWC

A Proton Exchange Membrane Fuel Cell “PEMFC” generates electricity through the passage of protons from hydrogen atoms through a membrane. The movement of the disassociated electrons around the membrane generates electricity. As shown in equation 1 (the anode half reaction) and equation 2 (the cathode half reaction).

Equation 1:

H2>2H++2e−

Equation 2:

½O2+2H++2e−>H2O+Heat

The heat generated during the passage of the electrons around the membrane and the formation of water at the cathode. The temperature for practical operation of the PEMFC is about 80 C. to about 120 C. However, the heat generated during operation, if not removed can cause the PEMFC to exceed 120 C. With increased temperature the performance of the PEMFC can diminish. See generally U.S. Pat. No. 6,066,408 issued to Vitale and Jones. Accordingly, it would also be desirous to have a fuel cell power supply for a PWC with integrated heat management.

It would therefore be desirous to have a PWC, with the primary propulsion system being electric, without a conventional battery power supply. Absent from the art is such a PWC.

Additionally, a self-recharging electric PWC without a conventional battery supply would also be desired.

### SUMMARY OF INVENTION

One exemplary implementation disclosed is an electric propulsion system for an electric small marine craft with a fuel cell providing at least some of the electricity for propulsion.

One exemplary implementation disclosed is an electric propulsion system for an electric small marine craft with a fuel cell providing at least some of the electricity directly for propulsion.

One exemplary implementation disclosed is an electric propulsion system for an electric small marine craft with a fuel cell providing at least some of the electricity indirectly (via recharging a fast recharging battery) for propulsion.

One exemplary implementation disclosed is an electric propulsion system for an electric small marine craft with a fuel cell providing at least some of the electricity directly and indirectly (via recharging a fast recharging battery) for propulsion.

One exemplary implementation disclosed is an electric small marine craft such as a PWC with a fuel cell providing electricity directly for non-propulsion electrical systems.

One exemplary implementation disclosed is an electric small marine craft such as a PWC with a fuel cell providing electricity indirectly (via recharging a fast recharging battery) for non-propulsion electrical systems.

One exemplary implementation disclosed is an electric small marine craft such as a PWC with a fuel cell providing electricity directly and indirectly for non-propulsion propulsion systems.

One exemplary implementation disclosed is that the small partially hollow hull of a PWC, or other small marine craft, which does not provide space for heavy and bulky batteries is well suited to carry an on-board supply of hydrogen. The oxygen for the fuel cell can be supplied from atmospheric air.

One exemplary implementation disclosed is that the small partially hollow hull of a PWC, or other small marine craft, which does not provide space for heavy and bulky batteries is well suited to carry an on-board system to generate hydrogen.

One exemplary implementation disclosed is that the electrical propulsion system for the craft can use output from a fuel cell stack to recharge a small fast recharging battery such as a nickel-metal hydride battery “NiMH”, a nickel-cadmium battery “NiCd” battery or other fast recharging battery. Unlike bulky conventional batteries, fast recharging small batteries can be recharged during operation with electrical output from an on-board fuel cell stack during or in-between operation.

One exemplary implementation disclosed is that the craft can use the electrical output from the fuel cell and the electrical output from a fast recharging battery to power one or more electric motors. In such an embodiment excess electricity produced by the fuel cell stack may also be used to recharge the fast recharging battery.

A heat exchanger, for thermal management of at least the fuel cell stack, through the hull of the craft is one exemplary implementation disclosed.

A heat exchanger, for thermal management of at least the fuel cell stack, with a radiator utilizing a flow of water from the marine environment is one exemplary implementation disclosed.

For an electric craft with as few as one electric motor primary propulsion module, a single impeller in a water tunnel can provide a water jet stream, exiting a discharge nozzle at the rear for propulsion. A directional nozzle affixed to the discharge nozzle can be used for steering and/or navigation. The combination of a water tunnel, impeller and discharge nozzle form the main components of a water jet propulsion module. The directional nozzle is controllably connected to handle bars which can be used to move the directional nozzle. A hand throttle can used to adjust the speed of the craft by controlling the speed of the electric motor thereby altering the rate of the water jet stream flow.

The craft may have two or more electric motors for the primary propulsion, each electric motor powered by the fuel cell stack and each connected to a propulsion module. For a dual motor craft, with rearward discharge nozzles, navigation and/or steering are effected by controlling the discharge of water from either or both of the discharge nozzles. Additional steering options can result from adding controllable directional nozzles.

The craft may have one or more rearward discharge nozzles, and at least one forward discharge nozzle (which expel a water stream generally rearward) on each side of the hull. By controlling the output of each forward water jet propulsion module and/or the rearward propulsion modules, propulsion and steering and/or navigation of the craft can be controlled.

The terms navigation and steering are use interchangeable throughout the specification. Navigation and/or steering is used to describe an act, action or sequence which is used to control the direction or path the PWC follows during operation.

Other features and advantages of the present invention will be set forth, in part, in the descriptions which follow and the accompanying drawings, wherein the preferred embodiments of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations particularly pointed out in the appended claims.

### BRIEF DESCRIPTION OF THE DRAWINGS

FIG. 1A is an external side view of an electric PWC.

FIG. 1B is a cut-away side view of the embodiment of FIG. 1A.

FIG. 1C is a bottom view of the embodiment of FIG. 1A.

FIG. 1D is a cut-away back view of the embodiment of FIG. 1A at line A-A.

FIG. 1E is a top view of the embodiment of FIG. 1A.

FIG. 2 is a block diagram of the major components of the power generation and propulsion system of an EFC PWC.

FIG. 3A is a back view of a dual motor PWC.

FIG. 3B is a partial bottom view of the embodiment of FIG. 3A.

FIG. 3C is a top view diagram, showing a turn, of the embodiment of FIG. 3A.

FIG. 4 is a block diagram of power and navigation components for a dual motor PWC.

FIG. 5 is a partial bottom view of an alternate embodiment of a dual motor PWC.

FIG. 6 is a block diagram of power and navigation components for a dual motor PWC.

FIG. 7 is a bottom of another embodiment of a PWC.

FIG. 8 is a block diagram of power and navigation components for a triple motor PWC.

FIG. 9 is a side representational view of a PWC with radiator cooling.

FIG. 10 is a block diagram of the major components of the power generation and propulsion system of another EFC PWC.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF PREFERRED EMBODIMENTS

Detailed embodiments of the present invention, including but not limited to a propulsion system for inclusion in a water craft, are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure.

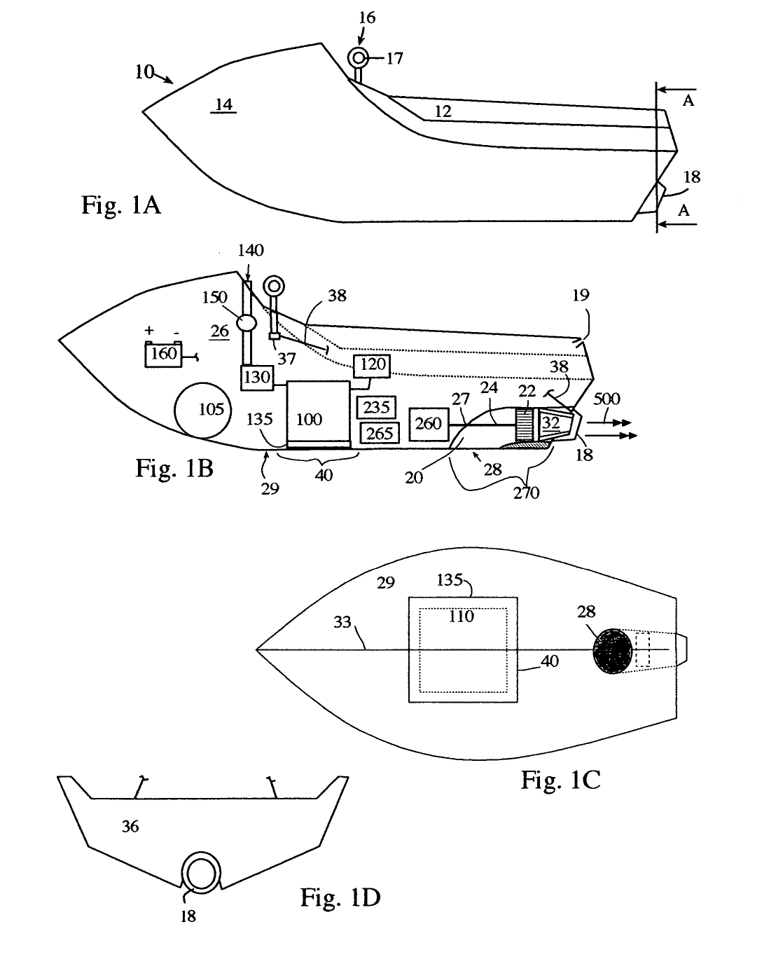

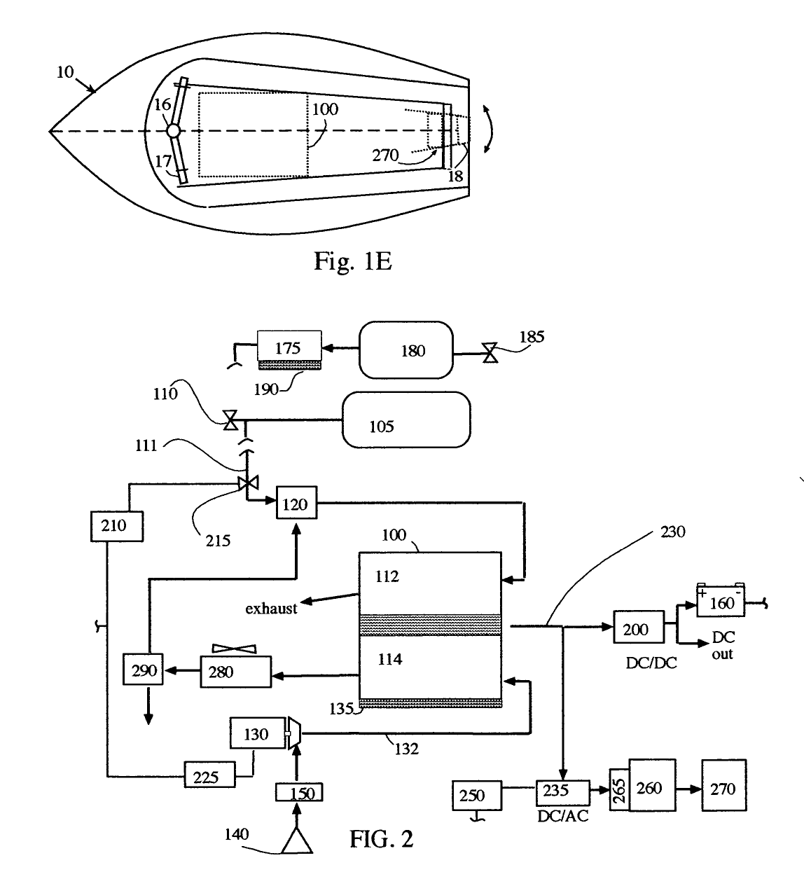

Shown in FIGS. 1A-1E is an electric water craft. More specifically, a personal water craft (hereinafter “PWC”) 10. This PWC has a seat 12 raised above the hull 14, the hull 14 has hollow portions therein. A handle bar on a support 16 provides a hand hold for a rider. A hand grip control 17 can be mounted on the handle bar on a support 16. The hand grip control 17, in this embodiment, is a substantially a motorcycle-type hand throttle which is well known in the art. The hand grip control 17 is used for speed control.

A steering nozzle 18 extends from the back of the hull 14. An electric motor powered by electricity generated from the fuel cell provides the propulsion for the PWC. Those skilled in the art will recognize that the propulsion system for the PWC shown in the figures is applicable to a small water craft which may have seating within a portion of the hull. A steering wheel may replace the handle bars. Lever throttle controls may replace the hand throttle. Vents 19 are also provided in the hull 14.

A schematic showing the some components of an “electric fuel cell” (EFC), water craft is shown in FIG. 2. The components of the EFC water craft are placed inside the hull 14 of a PWC (or extending therefrom). The “proton exchange membrane fuel cell stack” (PEMFC) 100 requires a supply of hydrogen and oxygen to generate electricity.

Hydrogen is delivered to the PEMFC 100 from a hydrogen supply system via at least one refillable hydrogen storage tank 105 with a fill valve 110 connected to a pressure rated hydrogen feed line 111 through which hydrogen flows to the anodes 112 of the fuel cell stack. Different configurations of PEMFC can utilize hydrogen at different pressure. Normally, as is known in the art, the pressure of the hydrogen dispensed from the tank 105 will be regulated by a pressure regulation device (not shown) and delivered to the anodes 112 at a pressure which is within the operating pressure for the membranes of the PEMFC. The hydrogen storage tank should have a pressure rating of at least 1000 psi and more preferably a pressure rating of at least 5000 psi, and most preferably a pressure rating of at least 10,000 psi. The hydrogen feed line 111 passes into a humidity control device 120 which adds moisture to the gaseous hydrogen before it flows to the PEMFC 100.

Oxygen is delivered oxygen to the PEMFC 100 from an oxygen supply system. An air compressor 130 draws atmospheric air down an air intake 140 through a filter 150 and directs the compressed air, through an air feed line 132 to the cathode(s) 114 of the PEMFC 100. The air compressor 130 is connected to a battery 160 to initiate the air compressor 130 operation.

The PEMFC 100, a hydrogen supply system (which delivers pressurized humid hydrogen to the PEMFC 100) and an oxygen supply system which delivers pressurized oxygen to the PEMFC 100 working together may be referred to as a “fuel cell power system”. Those skilled in the art will recognize that additional or varied components which perform the same functions as the elements of the hydrogen supply system or the oxygen supply system may be used as part of a fuel cell power system without departing form the intended scope of the invention herein.

Once the PEMFC 100 is operating (generating electricity) a DC/DC converter 200 may be used to step down the voltage and power on board systems such as the compressor 130 and other low voltage components, and to recharge the battery 160.

As indicated in equation 2 the operation of the PEMFC 100 generates heat. The PEMFC 100 is most efficient when operating between about 80 and about 120 C. By thermally connecting the PEMFC 100 with a fuel cell heat exchanger 135, through a heat exchange region 40 of the hull 14, to the marine environment the heat from operating the PEMFC 100 can be dissipated, dispersed and/or managed. Heat exchangers are well known in the art. In this embodiment the heat exchanger 135 is a finned metallic portion. Other configurations and types of heat exchangers, coolers, or radiators may also be suitable.

An alternate hydrogen supply system is also shown in FIG. 2. A reformer 175, which generally comprises a combustion chamber and a reaction chamber, is used to free gaseous hydrogen from a hydrogen rich fuel. The hydrogen rich fuel is supplied to the reformer 175 from an internal fuel tank 180. A fuel fill valve 185 is used to refill the fuel tank. Those skilled in the art will recognize that other hydrogen supply generation systems may be used in place of the High pressure storage tanks or reformation of hydrogen rich fuels. System include the use of hydrides as a lower pressure storage and the use of other reactive systems whereby hydrogen is released for use.

Reformers for generating hydrogen from hydrogen rich fuels are well represented in the art. No specific reformer is called out for. But rather, a reformer which can provide an adequate quantity of gaseous hydrogen to supply the consumption of the PEMFC 100. The reformation process is exothermic (heat producing) and a reformer heat exchanger 190 is shown in FIG. 2. The reformer heat exchanger 190 is used to thermally connect the reformer 175 to the marine environment (via a heat exchange region 40 of the PWC hull shown in FIG. 1C) to manage the heat generated by the reformer 175.

A fuel system controller 210 is used to control the on/off function of the hydrogen supply valve the 215 and the motor controller 225 for the compressor 130. In this embodiment electricity from the fuel cell stack is also received by an electric power inverter 235 with its own controller 250. The electric power inverter converts the DC voltage output of the fuel cell power system to AC voltage to operate an AC electric motor 260 which drives the water jet propulsion module 270. In some instances a DC motor may be preferable. The description herein of an AC motor is preferred and not intended as a limitation.

The speed of the PWC can be controlled by varying the electrical output of the PEMFC 100. Some of the procedures to vary the output of the PEMFC 100 is altering the hydrogen flow (via the hydrogen supply valve 215) and/or varying the available oxygen (via altering the action of the compressor 130). The speed of the PWC can also be controlled by varying the output of the inverter 235 and/or varying the speed of the electric motor 260. The speed of the electric motor 260 is adjusted by the motor speed control 265.

The size, current requirements, and electrical output of the electric motor 260 are dependent on the intended to usage of the EFC PWC. An EFC PWC for a single rider may require a less powerful motor than a EFC PWC for two or more riders.

Components of the water jet propulsion module 270, shown in FIG. 1B, are a water tunnel 20, an impeller 22 (connected to a motor shaft 24 which extends from inside the hull 26, through a sealed guide 27, into the water tunnel 20), a tunnel opening 28 through the bottom of the hull 29, and a discharge nozzle 32.

The AC electric motor 260, with motor speed controller 265, provides the primary propulsion for the PWC. The electric power inverter 235 provides the AC current. When the impeller 22 inside the water tunnel 20 rotates water is directed through the water tunnel 20 and forms a stream of water. The stream of water reaches the discharge nozzle 32 and exits the PWC. In this embodiment a steering nozzle 18 is connected to the discharge nozzle whereby the stream of water is movably directed. The discharge nozzle 32, in this embodiment, is placed near the centerline of the PWC 33 and at the backside of the hull 36. The stream of water passes through the steering nozzle and a water jet stream 500 exits. By controlling the direction of the water jet stream 500, relative to the PWC, the steering nozzle 18 is used in both propulsion and navigation of the PWC.

The steering nozzle 18 is physically controlled by the movement of the handle bars on a support 16. An actuator 37 is connected to the handle bars on a support 16 and the steering nozzle 18. Known in the art are many types of actuators including but not limited to wire-actuators, mechanical, electrical and hydraulic. Accordingly, a detailed description of an actuator is not provided. The actuator 37, in this embodiment with a linking rod 38, connects the handle bars 16 to the steering nozzle 18. Any actuator which react to the movement of the handle bars 16 and will provide a corresponding movement of the steering nozzles 18 can be used without departing from the scope of this invention.

The fuel cell heat exchanger 135 is in thermal contact with a heat exchange region 40 of the bottom of the hull 29. If a reformer 175 is being used to provide hydrogen, a reformer heat exchanger 185 can also be placed in contact with the heat exchange region 40. The heat exchange region 40 is constructed with good thermal conducting properties whereby the heat from the operation of the PEMFC 100 is dissipated into the marine environment. The heat exchange region 40, at its interface 41 with the hull bottom 29, should be constructed to avoid heat damage to itself, the hull, or the interface 41. The heat exchange region may be constructed with channels, fins or have other surface features, which are known in the art, to increase the surface area for heat exchange. In the present embodiment a metallic material, such as stainless steel can be used to construct the heat exchange region 40. However, it is within the scope of this disclosure that other metallic and non-metallic materials, such as metal alloys, resins, composites, insert molded metal and plastic, and ceramics may be used to form at least a part of the heat exchange region.

Other components connect to the fuel cell power system include, but are not limited to, the water management which is shown in this embodiment as a condenser 280 which receives an exhaust stream from the cathode and condenses the water therein. The condenser 280 can provide water for use in the humidity control device 120. The condensed water can be stored in a reservoir 290. In some embodiments a DC/DC converter may be connected to the fuel cell power system, in other embodiments a power inverter 235 may be used to covert the DC to AC. In some configurations both a DC/DC converter and a power inverter 235 to covert the DC to AC may be used.

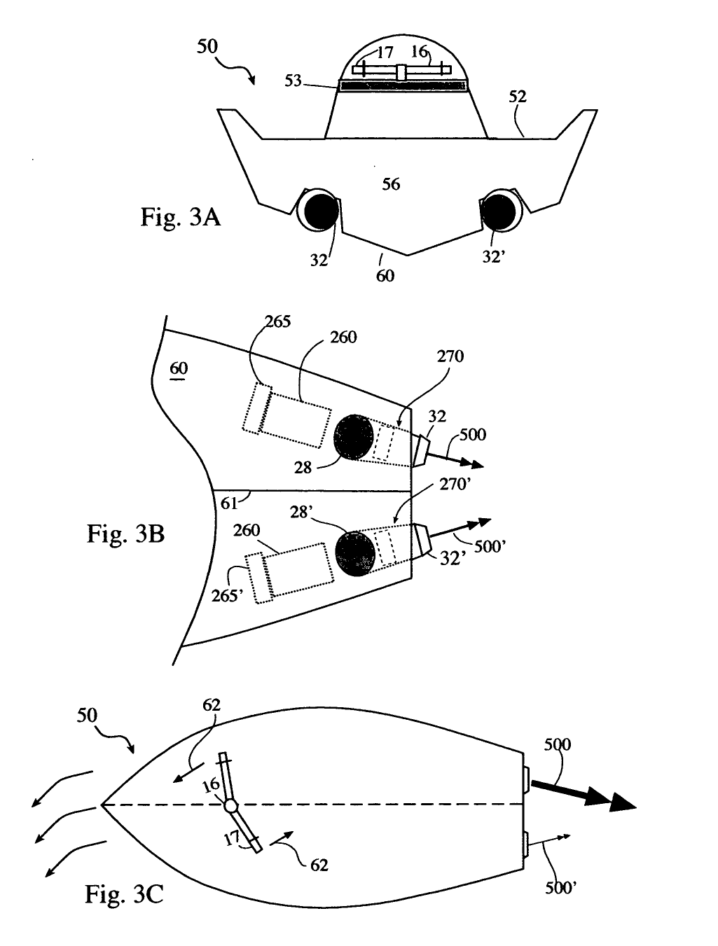

In FIG. 3A and 3B the EFC PWC 50 also has a hull 52 with a raised seat 53. Dual fixed discharge nozzles 32 & 32′, extend through the back of the hull 56. The dual fixed discharge nozzles 32 & 32′ are shown at a fixed angled with the water jet stream 500 & 500′ directed towards the centerline 61 of the hull 60. The first and second electric motors 260 & 260′ are each connected to a water jet propulsion module 270 and generally operates as described in reference to the embodiment described in FIGS. 1A-1E.

In this embodiment the water jet streams 500 & 500′ exits each water tunnel the discharge nozzles 32 & 32′. Weight shifting and varying the volume of discharged water in each of the water jet streams 500 & 500′ provide the propulsion and navigation. The volume of discharged water in a water jet stream is a time measurement. By varying the volume of water discharged over a period of time the PWC can be navigated, as shown in FIG. 3C.

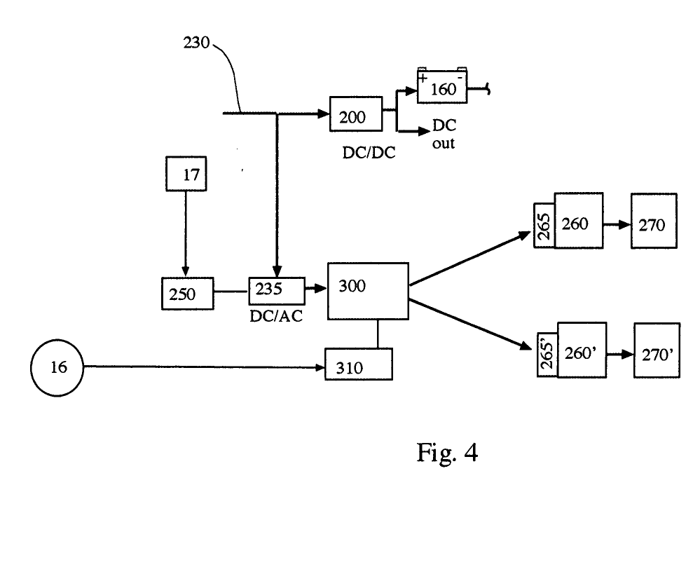

A load splitter 300, shown in FIG. 4 receives the electrical output from the inverter 235. The load splitter can divide up the power directed to each motor 260 & 260′. The load splitter 300 is controlled by a load splitter controller 310. The PEMFC 100 within the fuel cell power supply, supplies the current to the inverter 235. In this embodiment the movement of the handle bars 16 communicates with the load splitter controller 310 to vary the power to each motor 260 & 260′.

To turn the PWC left (shown in FIG. 3C) a user moves the handle bars 16 along the direction of arrow 62. The handle bar 16 movement communicates with the load splitter controller which directs the load splitter 300 to increases the electrical output to the right motor 260 as compared to the electrical output to the left motor 260′. The change in output to the electrical motors 260 & 260′ causes a change in the volume of discharged water in the water jet streams 500 & 500′. A rider can increase or decrease the forward speed of the PWC by adjustment of the total electrical output provided to the load splitter 300.

Electric motor(s) 260 can also power a propeller (not shown) extending from the hull 14. The use of the aforementioned water jet propulsion module (an impeller in a water tunnel with a discharge nozzle) to produce a water jet stream for propulsion is not a limitation of this invention. A propeller connected to a motor shaft can be used to provide propulsion and navigation for a fuel cell powered electric water craft. An impeller is preferred for those water crafts which have a rider above the hull, such a craft is likely to have riders approaching from the water and or falling off the craft the impeller eliminates the risk of injury from a propeller.

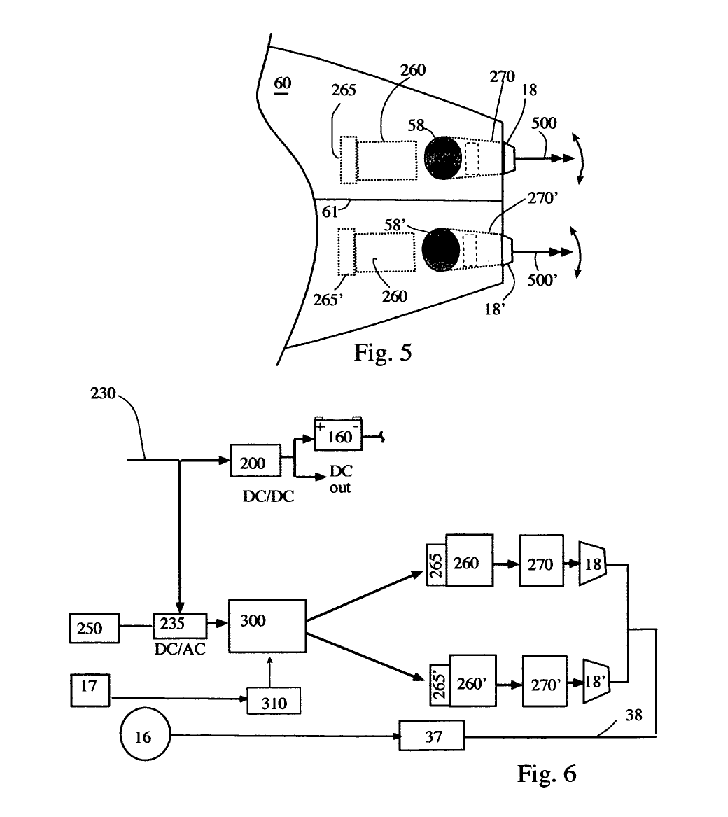

A dual motor PWC with dual steerable nozzles 18 & 18′ is shown in FIGS. 5 & 6. In this embodiment the load splitter 300 provides equal electrical output to each motor 260 & 260′. Navigation is by the same general mechanism described in reference to the embodiment shown in FIG. 1A-1E. The steering nozzles 18 & 18′ are located on either side of the centerline 61 and move together. Additionally varying the motor speed of either motor 260 & 260′ can be used instead of, or in addition to, using the directional steering nozzles for steering the craft. The steering nozzles are physically connected to each water jet propulsion module 270. The steering nozzles 18 & 18′ are controlled by the movement of the handle bars 16 which is connected to an actuator 37.

The load splitter 300, in this embodiment, splits the load substantially evenly (generally to produce the same RPM per motor) between each motor 260 & 260′.

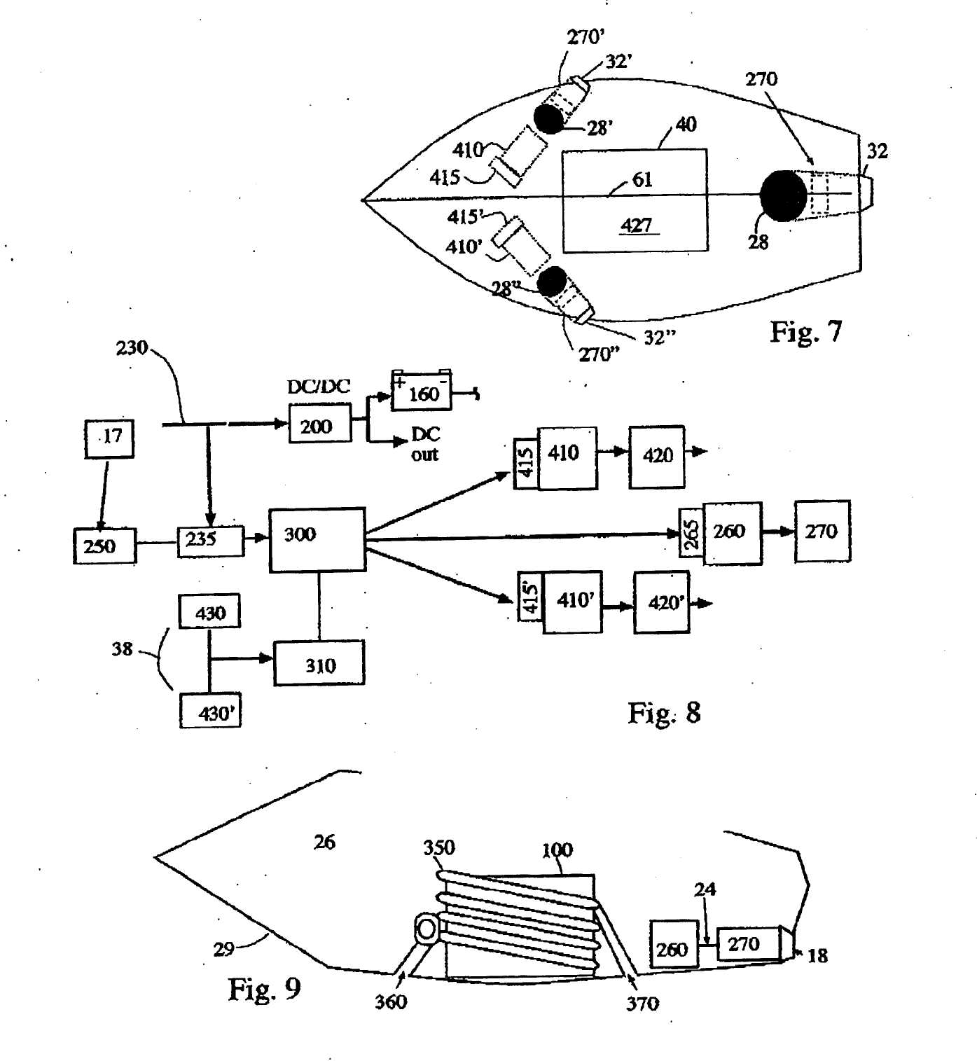

A triple electric motor PWC 70 is shown in FIGS. 7 & 8. In this embodiment the load splitter 300 provides electrical output to the rear motor 260 (and rearward water jet propulsion module 270) and to the two forward steering motors 410 & 410′. The forward steering motors 410 & 410′, each with a motor controller 415 & 415′, are angled away from the center line 61 and each is connected to a forward water jet propulsion module 270′& 270″.

As previously described, a load splitter 300 operates to direct a portion of the electricity from the PEMFC 100 (which is a part of the fuel cell power system) to the different motors. Specifically, to the rear motor 260 and the forward steering motors 410 & 410′, as needed. To steer the PWC left a rider (not shown) engages an actuator 37 which communicates with the load splitter controller 310 to power the right forward steering motor 410′.

In this embodiment the actuator is an actuator system which communicates with the load splitter controller 310 comprises dual foot controls 430 & 430′. In this embodiment the foot controls 430 & 430′ actuates the load splitter controller 310. The foot controls may be mechanical, hydraulic, or “by-wire” (electrical). To turn the PWC left a rider (not shown) places uneven pressure on the dual foot controls, with more pressure on the left foot control 430, the change in pressure on the left foot control 430 actuates the load splitter controller 310 and the load splitter 300 increase the electrical output to the right forward steering motor 410′. A rider can increase or decrease the forward of the PWC by adjustment of the total electrical output provided to the load splitter 300, via the hand grip 17. The foot controls 430 & 430′ could also be used to control a mechanical actuator to control steering nozzles.

Shown in FIG. 9 is another EFC PWC. In this embodiment the fuel cell stack 100 is cooled with an open radiator 350. The open radiator 250 has an intake opening 360 and an exhaust opening 370 through the bottom of the hull 29. A pump 380 can be used to bring water from the marine environment onto the open radiator 250 for cooling the fuel cell stack 100 and then returning the water through the exhaust opening 370.

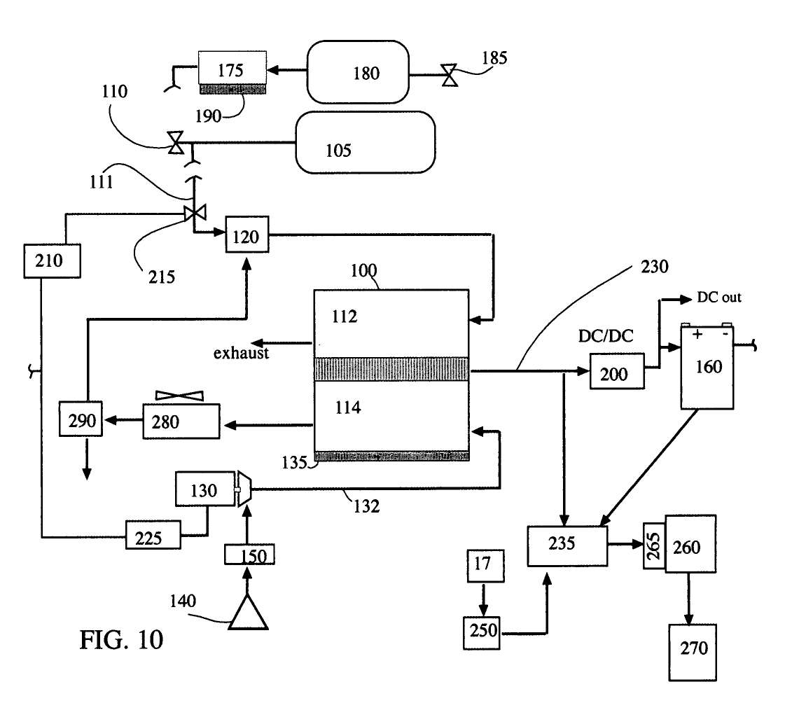

Shown in FIG. 10 is a schematic for some components of a system and method for another EFC water craft. The components of the EFC water craft are shown in FIG. 10 placed inside the hull 14 of a PWC (or extending therefrom). The hydrogen is supplied via a hydrogen supply system to the PEMFC 100 from a refillable hydrogen storage tank 105 with a fill valve 110 connected to a pressure rated hydrogen feed line 111 which is connected to the anode(s) 112 of the fuel cell stack. The hydrogen storage tank should have a pressure rating of at least 1000 psi and more preferably a pressure rating of at least 5000 psi, and most preferably a pressure rating of at least 10,000 psi.

During operation of the fuel cell power system, the hydrogen feed line 111 passes through a humidity control device 120 to add moisture to the gaseous hydrogen before it flows to the PEMFC 100. An oxygen supply system provides oxygen to the PEMFC 100. As previously described the air compressor 130 draws atmospheric air down an air intake 140 through a filter 150 and directs the compressed air, through an air feed line 132 to the cathode(s) 114 of the PEMFC 100. The air compressor 130 is connected to a battery 160 to initiate the air compressor 130 operation. Vents 19 are provided in the hull 14.

Once the fuel cell power system (and the PEMFC 100 therein) is operating (generating electricity) a DC/DC converter 200 is used to step down the voltage and power on board systems such as the compressor 130 and other low voltage components, and recharge the battery 160, which in this embodiment is preferably a NiMH battery.

The NiMH battery 160 or other fast charging battery can be used as a co-primary power supply along with the electricity generated from the output of the PEMFC 100 with a portion of the electricity for the motors supplied by the battery 160 and a portion of the electricity supplied from the PEMFC 100.

The NiMH battery or other fast charging battery 160 can be used as the primary power supply for the propulsion with the battery 160 recharged by the output of the PEMFC 100, of the fuel cell power system, via the DC/DC converter 200. A battery 160 refers to a suitable size battery power supply which may be a single battery or multiple batteries connected in series or parallel, depending on the power requirements of the water craft and/or the propulsion system.

A sensor 202 may be added to monitor the recharging of the battery 160. The sensor 202, when connected to the fuel system controller 210 (not shown) can be used to control the recharging of the battery 160 via the available electrical output from the PEMFC 100. The sensor 202, when connected to the DC/DC converter 200 can be used to control the recharge rate of the battery 160. The sensor may be connected to both the fuel system controller 210 and the DC/DC converter.

As indicated in equation 2 the operation of the PEMFC 100 generates heat. The PEMFC 100 is most efficient when operating between about 80 and about 120 C. By thermally connecting the PEMFC 100 with a fuel cell heat exchanger 135, through a heat exchange region 40 of the hull 14, to the marine environment the heat from operating the PEMFC 100 can be dissipated, dispersed and/or managed. Heat exchangers are well known in the art. In this embodiment the heat exchanger 135 is a finned metallic portion. Other configurations and types of heat exchangers, coolers, or radiators may also be suitable.

An alternate hydrogen supply is also shown in FIG. 2. A reformer 175, which generally comprises a combustion chamber and a reaction chamber, is used to free gaseous hydrogen from a hydrogen rich fuel. The hydrogen rich fuel is supplied to the reformer 175 from an internal fuel tank 180. A fuel fill valve 185 is used to refill the fuel tank.

Reformers for generating hydrogen from hydrogen rich fuels are well represented in the art. No specific reformer is called out for. But rather, a reformer which can provide an adequate quantity of gaseous hydrogen to supply the consumption of the fuel cell stack 100. The reformation process is exothermic (heat producing) and a reformer heat exchanger 190 is shown in FIG. 2. The reformer heat exchanger 190 is used to thermally connects the reformer 175 to the marine environment (via a heat exchange region 40 of the PWC hull shown in FIG. 1C) to manage the heat generated by the reformer 175.

A fuel system controller 210, is used to control the on/off function of the hydrogen supply valve the 215 and the compressor 130 motor controller 225. Electricity from the fuel cell stack is also received by an electric power inverter 235 with its own controller 250. The electric power inverter converts the DC voltage from the PEMFC 100 to AC voltage to operate an AC electric motor 260, with a speed controller motor, which drives the water jet propulsion module 270. In some instances a DC motor may be preferable. The illustration of an AC motor is not a limitation. Those skilled in the art will recognize that the DC/AC inverter may be by-passed or removed and the DC, conditioned through a DC/DC converter to provide the correct voltage to DC motors, in place of the AC motor(s).

In this embodiment the power inverter controller 250 is used to manage the available DC from the PEMFC 100, the battery 160 or both the PEMFC 100 (of the fuel cell power system) and battery 160.

In a DC configuration an inverter is not required, but rather the DC/DC converter is used to provide DC at the appropriate level for DC propulsion. In a hybrid fuel cell/battery PWC embodiment the output available from the battery 160 may also need to be conditioned to meet the DC needs of the DC motor(s). A controller can manage what proportion of DC supplied to the motor is from the PEMFC 100 and what proportion is from the—battery 160. The PEMFC may supply between 0 and about 100% of the electricity to the electric motor, The back-up battery may supply between 0 and about 100% of the electricity to the electric motor.

The speed of the PWC can be controlled by varying the electrical output of the fuel cell stack 100 and/or the draw of power from the battery 160. The output of the fuel cell stack 100 can be varied by altering the hydrogen flow, via the hydrogen supply valve and/or altering the action of the compressor 130 and thereby varying the available oxygen. The speed of the PWC can also be controlled by varying the output of the inverter 235 and/or varying the speed of the electric motor 260. The speed of the electric motor 260 is adjusted by the motor speed control 265.

The size, current requirements, and output (Kilowatts) of the electric motor 260 are dependent on the intended to usage of the EFC PWC. An EFC PWC for a single rider may require a less powerful motor than a EFC PWC for two or more riders. A PEMFC with an output of as little as about 1 kilowatts may be sufficient to recharge the battery 160. Those skilled in the art will recognize that depending on the type of battery to be recharged, the current requirements of the motor(s), water conditions, load of the craft (load meaning weight) and the performance requirements of the craft a PEMFC with an output above 1 kilowatts may be preferred. PEMFC in the 10 to 200 kilowatt size and above are known in the art. Accordingly, a suitable size PEMFC (kilowatt) necessarily will be a function of the use and design parameters of the craft, some of which have been identified above.

Since certain changes may be made in the above apparatus without departing from the scope of the invention herein involved, it is intended that all matter contained in the above description, as shown in the accompanying drawing, shall be interpreted in an illustrative, and not a limiting sense.

I claim:

1. An electrical power system within the hull of a small watercraft comprising:
a PEMFC;
a hydrogen supply system to supply hydrogen to the PEMFC;
an oxygen supply system to supply oxygen to the PEMFC; and,
a rechargeable battery to be recharged from at least a portion of the output of the PEMFC.

2. The electrical power system of claim 1 further comprising a propulsion module to receive electrical power provided by at least one of the PEMFC and the rechargeable battery.

3. The electrical power system of claim 1 wherein the hydrogen supply system further comprises at least one pressurized hydrogen storage tank.

4. The electrical power system of claim 1 wherein the hydrogen supply system further comprises a reformation means, whereby hydrogen is generated through the reformation of hydrogen rich fuels.

5. The electrical power system of claim 1 further comprising a DC/DC converter through which electrical power from the PEMFC is converted to a selected DC.

6. The electrical power system of claim 1 further comprising an inverter through which electrical power from the PEMFC is converted to a selected AC.

7. The electrical power system of claim 1 further comprising;
an inverter through which electrical power from the PEMFC is converted to a selected AC; and,
a DC/DC converter through which electrical power from the PEMFC is converted to a selected DC.

8. The electrical power system of claim 1 further comprising a controller whereby the recharging of the battery from the electricity produced by the PEMFC is controlled.

9. The electrical power system of claim 8 further comprising a sensor which provides information to the controller about the charge of the battery.

10. The electrical power system of claim 1 further comprising a through the hull heat exchange means.

11. The electrical power system of claim 10 wherein the through the hull heat exchange means is a fuel cell heat exchanger thermally connected to a heat exchange region.

12. The electrical power system of claim 2 further comprising at least one controller whereby the flow of electricity to the propulsion module can be varied.

13. The electrical power system of claim 1 further comprising a DC/DC converter through which electrical power from at least on one of the rechargeable battery and the PEMFC is converted to a selected DC.

14. The electrical power system of claim 1 further comprising an inverter through which electrical power from at least one of the rechargeable battery and the PEMFC is converted to a selected AC.

15. An electrical propulsion system within the hull of a small watercraft comprising:
a PEMFC;
a hydrogen supply system;
an oxygen supply system;
a rechargeable battery to be recharged from the output of the PEMFC; and,
a propulsion module to receive electrical power provided by the rechargeable battery.

16. The electrical power system of claim 15 wherein the hydrogen supply system further comprises at least one pressurized hydrogen storage tank.

17. The electrical power system of claim 15 wherein the hydrogen supply system further comprises a reformation means, whereby hydrogen is generated through the reformation of hydrogen rich fuels.

18. The electrical power system of claim 15 further comprising a DC/DC converter through which electrical power from the PEMFC is converted to a selected DC.

19. The electrical power system of claim 15 further comprising an inverter through which electrical power from the rechargeable battery is converted to a selected AC.

20. The electrical power system of claim 15 further comprising a controller whereby the recharging of the battery from the electricity produced by the PEMFC is controlled.

21. The electrical power system of claim 20 further comprising a sensor which provides information to the controller about the charge of the battery.

22. The electrical power system of claim 15 further comprising a through the hull heat exchange means.

23. The electrical power system of claim 22 wherein the through the hull heat exchange means is a fuel cell heat exchanger thermally connected to a heat exchange region.

24. The electrical power system of claim 15 further comprising at least one controller whereby the flow of electricity to the propulsion module can be varied.
